(19) United States
(12) Patent Application Publication
(10) Pub. No.: US 2009/0308526 A1
(43) Pub. Date: Dec. 17, 2009

(54) PROCESS FOR FORMING COVERINGS

(75) Inventor: David J. Gow, Edinburgh (GB)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Touch EMAS Limited, Edinburgh (GB)

(21) Appl. No.: 12/445,217

(22) PCT Filed: Oct. 12, 2007
(86) PCT No.: PCT/GB07/03905

§ 371 Date: Jun. 23, 2009

(30) Foreign Application Priority Data
Oct. 12, 2006 (GB) 0620250.1

(51) Int. Cl. B29C 51/02; B29C 51/06; B29C 51/42

(52) U.S. Cl. 156/245; 264/554; 264/552

(57) ABSTRACT

The present invention relates to a process (10) of forming a covering configured to be worn by a human or animal. The process (10) comprises the step of applying uncured silicone rubber to a textile substrate (14), the textile substrate comprising an elastic fibre that allows the textile substrate to stretch elastically, the textile substrate defining the general form of the covering. The process also comprises part curing the silicone rubber (16) such that the silicone rubber is sufficiently cured that the integrity of the silicone rubber can be substantially maintained and yet the silicone rubber is sufficiently uncured that a surface of the silicone rubber is impressible. The process (10) then comprises impressing a pattern on the surface of the part cured silicone rubber (20, 22).

### CROSS-REFERENCE TO RELATED APPLICATION

This application is a US National Phase Application of PCT International Application No. PCT/GB2007/003905 filed Oct. 12, 2007 (WO 2008/044052 A1, published Apr. 17, 2008), which claims priority of United Kingdom Application No. 0620250.1 filed Oct. 12, 2006, which is herein incorporated by reference.

### FIELD OF THE INVENTION

The present invention relates to a process for forming coverings configured to be worn by humans or animals.

### BACKGROUND TO THE INVENTION

It is known to form coverings for prostheses, such as prosthetic hands, from materials such as silicone rubber. Many manufacturing methods are known such as rotational “slush moulding” or paste “pack” moulding using three part moulds. The former method can produce highly detailed seamless gloves but usually requires solvents to disperse the relatively viscous base silicone and the latter method results in mould seams or flash which must be trimmed or abraded away. According to other conventional processes a sheet covered with silicone rubber is formed e.g. by rolling, from a mass of uncured silicone rubber. The silicone rubber may also be coloured such that the formed sheet has some skin tone. The formed sheet is then wrapped around the prosthesis to be covered and the sheet hand shaped and formed in-situ until the sheet has the desired shape and skin detail.

### STATEMENT OF INVENTION

The present inventor has appreciated that such conventional processes have shortcomings and the present invention has been devised in the light of this appreciation. Therefore according to a first aspect of the present invention, there is provided a process of forming a covering configured to be worn by a human or animal, the process comprising the steps of:
applying uncured silicone rubber to a textile substrate, the textile substrate comprising an elastic fibre that allows the textile substrate to stretch elastically, the textile substrate defining the general form of the covering;
part curing the silicone rubber such that the silicone rubber is sufficiently cured that the integrity of the silicone rubber can be substantially maintained and yet the silicone rubber is sufficiently uncured that a surface of the silicone rubber is impressible; and
impressing a pattern on the surface of the part cured silicone rubber.

The step of part curing the silicone rubber such that the integrity of the silicone rubber can be substantially maintained provides for ease of further handling or processing. More specifically, the following step of impressing a pattern may be carried out without prejudicing the integrity of the silicone rubber. For example, if the surface were to be patterned by means of an embossed roller, forces exerted by the roller on the surface of the silicone rubber are less likely to cause the silicone rubber to tear, split or become undesirably thin where the roller is applied. The phrase impressing a pattern is to be interpreted as meaning applying pressure to the surface of the part cured silicone rubber such that a surface profile of the surface is changed. Thus, impressing a pattern means creating an impression of the pattern in the surface of the part cured silicone rubber.

The present invention provides for more rapid forming of a covering compared with the above described conventional process. According to the invention a covering may be formed in as little time as two hours whereas forming a covering, e.g. for a prosthesis, according to the conventional process may take many hours. In addition, forming a covering of silicone rubber and a stretchable textile substrate may provide for: ease of flexing and stretching of the covering and durability of the covering in use. Furthermore, the present invention may be suitable for mass production of coverings.

In a first form, the step of impressing a pattern on the surface may comprise applying a mould bearing a pattern over at least a part of the surface of the part cured silicone rubber. A surface profile of the mould may define the pattern. Thus, impressing the surface of the silicone rubber with the pattern may cause an impression of the pattern to be formed in the surface of the silicone rubber.

More specifically, the mould may be formed at least in part of an elastic material.

More specifically, the elastic material may comprise latex at least in part.

Alternatively, the mould may be formed at least in part of a silicone rubber, such as a tin-based silicone rubber or a platinum based silicone rubber.

Alternatively or in addition, the mould may be of a thickness of substantially 1 mm.

Alternatively or in addition, at least one of the textile substrate and the mould may be moved such that the silicone rubber on the textile substrate and the mould are pressed against each other.

Alternatively or in addition, the textile substrate and the mould may be moved in relation to each other by controlling a pressure of air surrounding at least one of the textile substrate and the mould. For example, a pressure on an inside surface of the textile substrate may be greater than a pressure on an opposing, outside surface of the textile substrate presented towards the mould, whereby the silicone rubber on the textile substrate is pushed against the mould.

Alternatively or in addition, a pressure difference may be applied between an interior surface of the mould, which is to be applied to the surface of the silicone rubber, and an opposing, exterior surface of the mould. For example, a pressure less than ambient pressure may be applied at the interior surface of the mould when the pressure at the exterior surface of the mould is at ambient pressure. Thus, the mould may be pulled against the surface of the silicone rubber to provide for effective patterning of the surface of the silicone rubber.

Alternatively or in addition, the silicone rubber and the mould may be pressed against each other for between substantially thirty minutes and substantially forty-five minutes. This period of time may allow for the silicone rubber to be impressed with a pattern and to further cure such that the pattern remains impressed on the silicone rubber.

Alternatively or in addition, the mould may cover the surface of the silicone rubber for sufficient time to allow the silicone rubber to cure properly. Allowing the silicone rubber to cure when covered can provide for a matt surface appearance, which can be desirable for cosmetic reasons. Allowing the silicone rubber to cure when uncovered can, in contrast, provide a shiny surface appearance.

More specifically, the mould may be applied to the surface of the silicone rubber for a period of about one hour. More specifically, the period of about one hour may be greater than or in addition to the period during which the silicone rubber and the mould are pressed against each other.

Where the mould comprises latex, particulate matter may be applied to at least one of: the surface of the silicone rubber; and the surface of the mould to be applied to the surface of the silicone rubber, before the mould is applied to the surface of the silicone rubber.

The particulate matter may provide a lubricant effect easing movement of the mould in relation to the covering.

More specifically, the particulate matter may comprise talcum powder. The talcum powder may provide a barrier between the silicone rubber and the latex. This can be advantageous because latex has a tendency to poison silicone rubber, in particular where the silicone rubber comprises a platinum-based silicone rubber.

Where the mould comprises silicone rubber, a release substance comprising a grease may be applied to at least one of: the surface of the silicone rubber; and the surface of the mould to be applied to the surface of the silicone rubber, before the mould is applied to the surface of the silicone rubber.

More specifically, the grease may comprise one of Vaseline and paraffin wax.

Alternatively or in addition, the release substance may comprise a grease in a liquid solvent. The release substance may be applied as a thin coat, e.g. by painting or dipping of the mould or silicone rubber in the release substance. Application of a release substance in a liquid form may make it easier to achieve proper coverage and to determine whether or not proper coverage has been achieved compared to application of a release substance in aerosol form.

Alternatively or in addition, the step of part curing the silicone rubber may take substantially thirty minutes. The curing time may depend on the amount of catalyst used. However, the figure of substantially thirty minutes is typical in forms of the method.

In a second form, the step of impressing a pattern on the surface may comprise applying at least a part of the surface of the part cured silicone rubber over a support arrangement (e.g. a second mandrel) having a pattern on its surface such that the pattern is impressed on the part cured silicone rubber.

More specifically, the silicone rubber may be applied to the textile substrate when the textile substrate is supported on a forming arrangement (e.g. a first mandrel). The forming arrangement may be generally of the shape desired of the covering and of a shape that provides for ease of application of the silicone rubber to the textile substrate.

Alternatively or in addition, the part formed covering may be turned inside out such that a surface of the part formed covering is presented to the pattern on the support arrangement (e.g. the second mandrel) when the covering is supported on the support arrangement. The part cured silicone rubber may be pulled against the pattern by means described above with reference to the first form, such as the vacuum approach.

Further embodiments of the second form may comprise one or more features of the first form described above. 1 Alternatively or in addition, the textile substrate may comprise a spandex material, such as Lycra™.

More specifically, the textile substrate may comprise substantially 4% to substantially 12% Lycra™. More specifically the textile substrate may comprise substantially 8% Lycra™ to 12% Lycra™. Substantially 8% to substantially 12% Lycra™ has been found to provide superior performance as regards ability to stretch and integrity of the covering when formed and when in use. More specifically, the textile substrate may comprise substantially 8% Lycra™, which has been found to have appropriate properties for certain applications.

Alternatively or in addition, the textile substrate may have a pitch of (e.g. be knitted as) substantially 591 needles per metre (15 needles to the inch).

The spandex material can provide for stretching of the covering. For example, where the covering is for a prosthetic hand, the stretchability of the spandex material provides for ease of flexing of the covering in the region of moveable joints of the prosthetic hand.

Alternatively or in addition, the textile substrate may comprise nylon. The nylon may provide for a degree of stretching of the covering. More particularly, the nylon can allow the covering to conform to a surface profile of whatever the covering covers, e.g. a prosthetic hand.

Alternatively or in addition, the textile substrate may be unitary. More specifically, the textile may be seamless, i.e. formed of one piece of textile.

Alternatively or in addition, the textile substrate may have a thickness of substantially 0.6 mm.

Alternatively or in addition, the textile substrate may be supported on a support arrangement, e.g. on a mandrel, before the uncured silicone rubber is applied.

More specifically, the support arrangement may be rotated to rotate the textile substrate as the uncured silicone rubber is applied. Thus, silicone rubber can be more readily applied over all required parts of the textile substrate.

Alternatively or in addition the textile substrate may be supported on the support arrangement as the silicone rubber part cures.

More specifically, the support arrangement may be rotated for at least some of the time that the silicone rubber is curing. Thus an even distribution of silicone rubber on the textile substrate can be obtained.

Alternatively or in addition, the textile substrate may be supported on the support arrangement as a pattern is impressed on the surface of the silicone rubber.

Alternatively or in addition, the textile substrate may be supported on a further support arrangement, e.g. on a second mandrel, after the uncured silicone rubber is applied. Thus, the partly formed covering may be removed from the support arrangement (i.e. the first support arrangement) and moved to the further support arrangement either before or after the impressing of a pattern on the surface of the silicone rubber.

More specifically, the further support arrangement may have a form that is more similar to the form of a prosthesis to be covered by the covering than the first support arrangement. Thus, the first support arrangement may be of form that is generally of the shape of a prosthesis to be covered by the covering and which is suitable for the application of silicone rubber to the textile substrate, perhaps as part of a manufacturing process. The use of two support arrangements can lend itself to higher volume manufacture of coverings.

Alternatively or in addition, the step of applying the uncured silicone rubber may comprise applying silicone rubber when it is in the form of a flowing liquid.

Alternatively or in addition, the step of applying the uncured silicone rubber may comprise applying silicone rubber when it is in the form of paste. Thus, the paste may be applied to the textile substrate by means of a spatula or the like or laid down upon the textile when the consistency of the paste permits. Applying the silicone rubber to the textile substrate when it is in the form of a paste may make it easier to achieve a more even distribution of silicone rubber, e.g. between the digits of a covering for a prosthetic hand.

Alternatively or in addition, the process may further comprise the step of colouring the silicone rubber.

More specifically, the step of colouring the silicone rubber may be carried out before the uncured silicone rubber is applied to the textile substrate. Thus, the silicone rubber may be coloured to have a skin tone, where the covering is to be used to cover, for example, a prosthetic hand.

Alternatively or in addition, the silicone rubber may comprise one of: a tin-based silicone rubber, such as Repsil™ T; and a platinum-based silicone rubber. Where tin-based silicone rubber is used, a latex mould may be used. Where platinum-based silicone rubber is used, a silicone rubber mould may be used. This is because platinum based silicone rubber is normally poisoned by latex.

Alternatively or in addition, the process may comprise the steps of applying a further layer of uncured silicone rubber to the already applied and part cured silicone rubber.

More specifically, the further layer of uncured silicone rubber may be applied before the already applied silicone rubber is patterned.

The further layer may be used to create surface features on the covering. For example, where the covering is for a prosthetic hand, the surface features may include knuckles on the digits of the hand.

Alternatively or in addition, the further (i.e. second) layer of silicone rubber may comprise at least in part a tin-based silicone rubber. A tin-based silicone rubber has been found to be normally less liable to be poisoned by latex. Thus, a latex mould may be used to impress the pattern.

More specifically, the first layer of silicone rubber may comprise at least in part a tin-based silicone rubber.

Alternatively or in addition, further (i.e. second) layer of silicone rubber may comprise at least in part a platinum-based silicone rubber. A platinum-based silicone rubber is normally poisoned by latex. Thus, a silicone rubber mould may be used to impress the pattern.

More specifically, the first layer of silicone rubber may comprise at least in part a platinum-based silicone rubber.

Alternatively or in addition, the further applied silicone rubber and the already applied silicone rubber may be of a different colour to each other.—Thus a cosmetic effect of the covering may be enhanced, for example, by providing a red colouring on appropriate parts of the covering where the covering is for a prosthesis.

Alternatively or in addition, impressing a pattern on the surface of the part cured silicone rubber may comprise providing skin detail on the surface. The skin detail might include wrinkles, finger prints and the like.

Alternatively or in addition, the process may further comprise configuring the covering such that the covering can cover a prosthesis, such as a prosthetic hand.

More specifically, configuring the covering may comprise forming the textile substrate such that it is of a predetermined shape, e.g. glove shaped in the case of a prosthetic hand.

Alternatively or in addition, the process may further comprise configuring the covering such that the covering can form part of an orthosis.

Alternatively or in addition, the process may further comprise configuring the covering such that it can form an item of clothing or part of an item of clothing.

### BRIEF DESCRIPTION OF THE DRAWINGS

Further features and advantages of the present invention will become apparent from the following specific description, which is given by way of example only and with reference to the accompanying drawings.

FIG. 1 shows the process according to the present invention.

FIG. 2 is a plan view of a covering for a prosthetic hand formed according to the process of FIG. 1.

### SPECIFIC DESCRIPTION

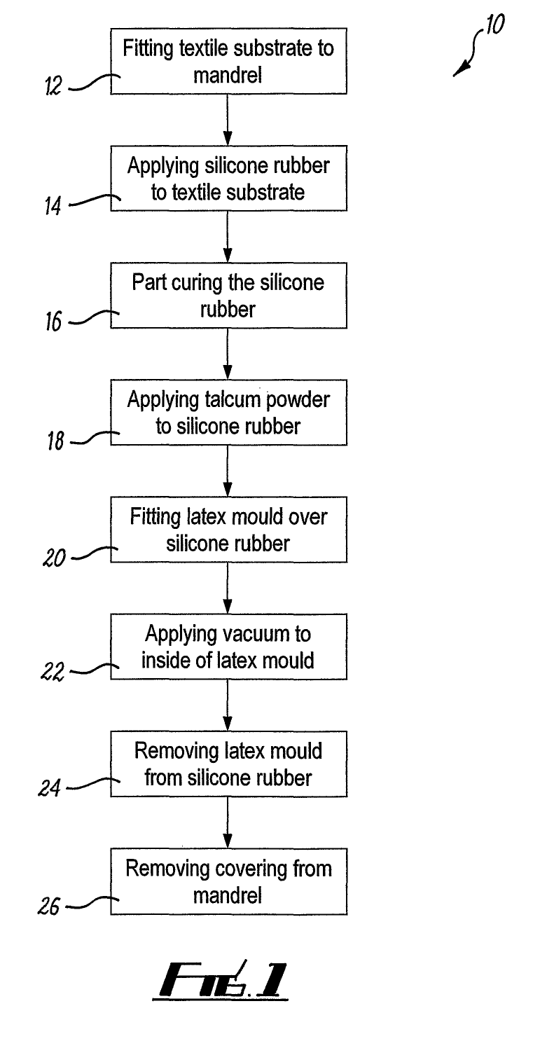

According to FIG. 1 the process for forming a covering for a prosthetic hand 10 starts by fitting a textile substrate to a mandrel 12. The textile substrate is of the shape of a glove and defines the shape of the formed covering. The textile substrate is formed of 92% nylon and 8% Lycra™. The nylon and Lycra are woven with a pitch of substantially 591 needles per metre 15 needles per inch). Uncured silicone rubber is coloured to take on a skin tone. The silicone rubber used is Repsil™ T formerly supplied by Replication Technologies Ltd of Unit 38 Hillgrove Business Park, Nazeing Road, Nazeing, Waltham Abbey, Essex, EN9 2HB (now supplied by WP Notcutt, Homewood Farm, Newark lane, Ripley, Surrey GU23 6DJ). Silicone pigments used are supplied by Principality Medical Ltd, Western Valley Road, Rogertone, Newport, South Wales, NP10 9DS.

The coloured silicone rubber is then poured onto the textile substrate as the mandrel rotates 14. Rotation of the mandrel provides. for exposure of all surfaces of the textile substrate so that the surfaces are properly covered with silicone rubber and the silicone rubber is evenly distributed over the textile substrate. The silicone rubber sits mainly on top of the textile substrate although some of the silicone rubber is present in the interstices between the fibres of the textile. The presence of some silicone rubber in the interstices between the fibres provides for secure attachment of the silicone rubber to the textile substrate. Then the poured silicone rubber is allowed to part cure 16. During initial curing of the silicone rubber the mandrel is rotated to maintain an even distribution of silicone rubber. For uncured silicone rubber a period of about thirty minutes is normally appropriate. The silicone rubber is part cured when the silicone rubber is less liable to tear or split on handling but is sufficiently uncured at its surface to permit a pattern to be impressed upon it.

Talcum powder is applied to the surface of the part cured silicone rubber 18. The talcum powder provides lubrication for the fitting of a latex mould over the silicone rubber. The talcum powder also reduces the likelihood of the silicon rubber being poisoned by the latex. The latex mould has had a pattern formed on its inside surface. The pattern comprises surface features such as wrinkles and finger prints. The pattern is formed on the latex mould by well known means. The latex mould has a thickness of about 1 mm.

In an alternative embodiment a platinum based silicone rubber is used instead of Repsil™ T, which is tin-based silicone rubber. Platinum based silicone rubbers are more liable to be poisoned by latex. Hence, the mould is formed of silicone rubber instead of latex. Either a platinum-based or a tin-based silicone rubber may be used for the mould. According to this embodiment, a release substance is applied as a thin coating to one, other or both of the mould and the silicone rubber surface that will come into contact with the mould. The release substance comprises vaseline in a solvent, which is painted onto surfaces to be coated. Alternatively, surfaces to be coated are dipped into the release substance.

When the latex mould is in position, a vacuum is applied to the inside of the latex mould by known means to pull the inside surface of the latex mould against the surface of the silicone rubber 22. Thus, the pattern on the latex mould is impressed upon the surface of the silicone rubber. The latex mould is kept in position such that it is pulled against the surface of the silicone rubber for between about thirty minutes and about forty-five minutes.

The vacuum is then released so that the latex mould is no longer pulled against the silicone rubber. The latex mould is kept in place over the silicone rubber for about one hour, which is normally a sufficient period of time to allow the silicone rubber to cure properly. This provides for a matt finish to the silicone rubber.

The latex mould is then removed from the mandrel 24 and the now formed covering is removed from the mandrel 26. The formed covering is now ready to be fitted to a prosthetic hand.

In the process described above the amount of softener can be increased to provide for increased flexibility in the silicone rubber when cured. However, the increase in flexibility reduces the strength of the silicone rubber. Thus, the thickness of the textile substrate should be increased to maintain a given strength for the covering. Normally, between about 50% and about 100% of softener in relation to the silicone rubber is used. In certain circumstances where a high degree of flexibility is desired as much as about 200% of softener is used.

Silicone rubber is a suitable material because it is comparatively inert, does not tend to pick up dirt, has the properties of being elastic and resilient and can be relatively readily coloured. The presence of the nylon-Lycra™ textile substrate provides for strength of the covering. Thus, the covering can have a thinner layer of silicone rubber than would otherwise be the case were the textile substrate absent. Indeed, the combined thickness of the textile substrate and the silicone rubber is less than that of a covering formed of silicone rubber alone for a given strength requirement for the covering.

In an alternative embodiment, a first layer of a tin-based silicone rubber or a platinum-based silicone rubber is formed as described above before being allowed to cure at least in part. Then a second layer of the same type of silicone rubber (i.e. tin or platinum-based) is applied over the first layer before a pattern is impressed on the surface of the second layer as described above. The second layer of silicone rubber is thinner than the first layer of silicone rubber. Where platinum-based silicone rubber is used, a mould formed of silicone rubber is used instead of latex because platinum-based silicone rubber is liable to be poisoned by latex.

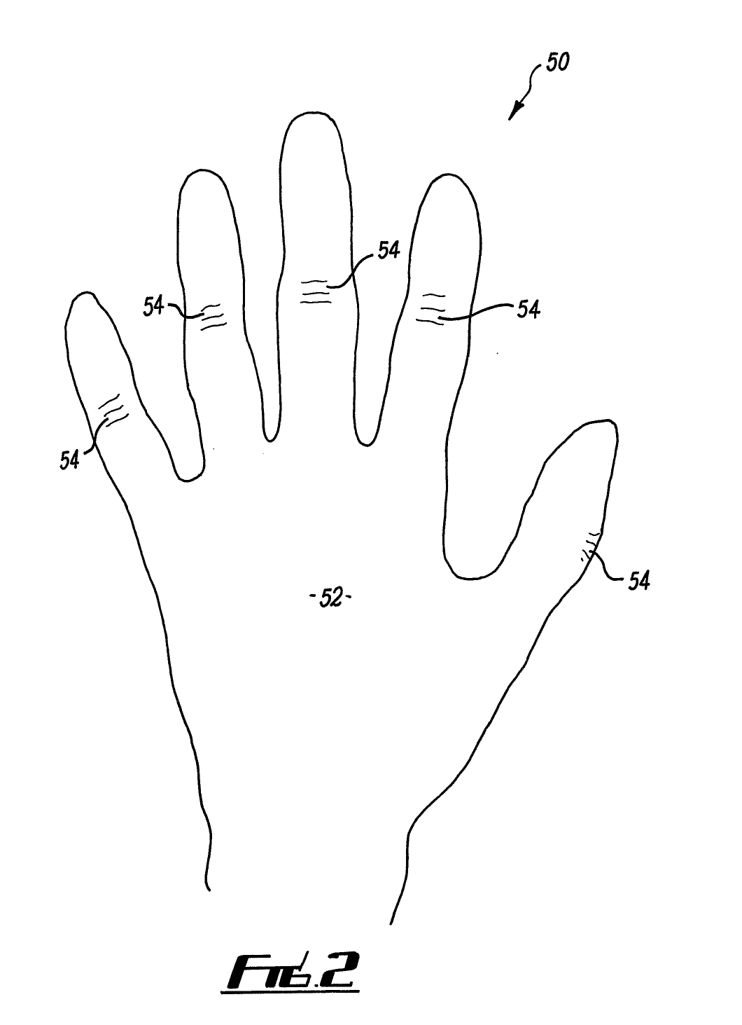

FIG. 2 shows a covering 50 for a prosthetic hand formed by the process of FIG. 1. The outside surface 52 of the covering consists of silicone rubber and the inside surface (not shown) consists of the textile substrate. The step of impressing a pattern 20, 22 provides skin detail, such as wrinkles 54 around knuckles of the covering.

Coverings for other forms of prosthesis, such as feet, can be formed by changing the shape of the textile substrate and the mandrel accordingly. Similarly, coverings for orthoses can be formed. Indeed, the process according to the present invention can be used to form items or parts of items of clothing to be worn by humans or animals, such as gloves or hats.

In another form of the invention, the coloured silicone rubber is formed as a paste which is then applied by means of a spatula or the like to the surface of the textile substrate. This is instead of pouring liquid silicone rubber onto the textile substrate. Thus, with this form of the invention there is less need to rotate the mandrel to provide for an even distribution of silicone rubber. The mandrel may be moved, e.g. rotated, to provide for ease of access to all surfaces of the textile substrate as the paste is applied. Under certain circumstances the paste may be formed such that it takes a certain shape, with the shaped paste then laid down onto the surface of the textile substrate.

In a further form of the invention, the part formed covering is removed from the mandrel after the application of the silicone rubber and either before or after the silicone rubber is patterned. The part formed covering is then supported on a second mandrel that has a shape that is similar to a prosthetic hand to be covered by the covering. Thus, the covering is roughly fashioned on the first mandrel, which is shaped to provide for ease of application of the silicone rubber, and then given its desired shape on the second mandrel before the silicone rubber cures properly.

In a yet further form of the invention, the latex mould may be dispensed with by patterning the silicone rubber by means of the second mandrel. According to this form of the invention, the second mandrel bears the desired pattern on its surface. After the part formed covering is removed from the first mandrel it is turned inside out and placed on the second mandrel such that its now inner surface is presented to the pattern. The surface of the silicone rubber to be patterned and the pattern on the second mandrel are pressed together by means of a vacuum as described above.

1-57. (canceled)

58. A process of forming a covering configured to be worn by a human or animal, the process comprising the steps of:
applying uncured silicone rubber to a textile substrate, the textile substrate comprising an elastic fibre that allows the textile substrate to stretch elastically, the textile substrate defining the general form of the covering;
part curing the silicone rubber such that the silicone rubber is sufficiently cured that the integrity of the silicone rubber can be maintained and yet the silicone rubber is sufficiently uncured that a surface of the silicone rubber is impressible; and
impressing a pattern on the surface of the part cured silicone rubber.

59. A process according to claim 58, in which the step of impressing a pattern on the surface comprises applying a mould bearing a pattern over at least a part of the surface of the part cured silicone rubber.

60. A process according to claim 59, in which the mould is formed at least in part of an elastic material.

61. A process according to claim 60, in which the elastic material comprises latex.

62. A process according to claim 59, in which at least one of the textile substrate and the mould are moved such that the mould and the silicone rubber on the textile substrate are pressed against each other, the textile substrate and the mould being moved in relation to each other by controlling a pressure of air surrounding at least one of the textile substrate and the mould.

63. A process according to claim 62, in which a pressure difference is applied between an interior surface of the mould, which is to be applied to the surface of the silicone rubber, and an opposing, exterior surface of the mould.

64. A process according to claim 63, in which a pressure less than ambient pressure is applied at the interior surface of the mould when the pressure at the exterior surface of the mould is at ambient pressure.

65. A process according to claim 59 and where the mould comprises latex, in which particulate matter is applied to at least one of: the surface of the silicone rubber; and the surface of the mould to be applied to the surface of the silicone rubber, before the mould is applied to the surface of the silicone rubber.

66. A process according to claim 58 comprising: applying the uncured silicone rubber to the textile substrate when the textile substrate is supported on a forming arrangement; and applying at least a part of the surface of the part cured silicone rubber over a support arrangement having a pattern on its surface and such that the pattern is impressed on the part cured silicone rubber, the part formed covering being turned inside out such that a surface of the part formed covering is presented to the pattern on the support arrangement when the covering is supported on the support arrangement.

67. A process according to claim 58, in which the textile substrate comprises a spandex material.

68. A process according to claim 58, in which the textile substrate comprises substantially 8% to substantially 12% spandex material.

69. A process according to claim 58, in which the textile substrate comprises nylon.

70. A process according to claim 58, in which the textile substrate is supported on a support arrangement before the uncured silicone rubber is applied.

71. A process according to claim 70, in which the support arrangement is rotated to rotate the textile substrate as the uncured silicone rubber is applied.

72. A process according to claim 70, in which the textile substrate is supported on the support arrangement as the silicone rubber part cures and the support arrangement is rotated for at least some of the time that the silicone rubber is curing.

73. A process according to claim 70, in which the textile substrate is supported on a further support arrangement after the uncured silicone rubber is applied, the further support arrangement having a form that is more similar to the form of a prosthesis to be covered by the covering than the first support arrangement.

74. A process according to claim 58 further comprising the step of applying a further layer of uncured silicone rubber to the already applied and part cured silicone rubber, the further layer of uncured silicone rubber being patterned.

75. A process according to claim 58, in which the silicone rubber comprises one of: a tin-based silicone rubber; and a platinum-based silicone rubber.

76. A process according to claim 75, in which the first layer of silicone rubber comprises at least in part a same type of silicone rubber as is comprised in the second layer of silicone rubber.

77. A process according to claim 58 further comprising configuring the covering such that the covering can cover a prosthesis.
